(19) United States
(12) Patent Application Publication
(10) Pub. No.: US 2015/0332158 A1
(43) Pub. Date: Nov. 19, 2015

(54) MINING STRONG RELEVANCE BETWEEN HETEROGENEOUS ENTITIES FROM THEIR CO-OCURRENCES

(71) Applicant: INTERNATIONAL BUSINESS MACHINES CORPORATION, ARMONK, NY (US)

(72) Inventors: Qi He, San Jose, CA (US); Ming Ji, Cupertino, CA (US); W. Scott Spangler, San Martin, CA (US)

(73) Assignee: INTERNATIONAL BUSINESS MACHINES CORPORATION, ARMONK, NY (US)

(21) Appl. No.: 14/279,617

(22) Filed: May 16, 2014

(51) Int. Cl. G06N 7/00; G06F 17/30; G06N 99/00

(52) U.S. Cl. CPC G06N 7/005; G06N 99/005; G06F 17/30958; G06F 17/30964

(57) ABSTRACT

Given two heterogeneous entities, the prevalence of text data provides rich co-occurrence information for them. However, the co-occurrence only is noisy—not only may the co-occurrence just imply an accidental writing, but also it may just reflect the domain-specific common words. Only those strong relevance between entities supported by rich relevance contexts in data can indicate meaningful entity relationships. Strong relevance between heterogeneous entities are mined from their co-occurrences. Drug-disease therapeutic relationships are used as the example to demonstrate an application of this work.

### BACKGROUND OF THE INVENTION

1. Field of Invention

The present invention relates generally to the field of identifying relevance between heterogeneous entities. More specifically, the present invention is related to a system, method and article of manufacture for mining strong relevance between heterogeneous entities from their co-occurrences.

2. Discussion of Related Art

In the biomedical domain, it is recognized that the text data describing different types of biological entities could be employed to facilitate drug discovery (see for example, the paper to D. Searls titled “Data Integration: Challenges for Drug Discovery” [source: Nature Reviews Drug Discovery, Vol. 4, No. 1, 2005]). The paper to Gunther et al. titled “Prediction of Clinical Drug Efficacy by Classification of Drug-Induced Genomic Expression Profiles In Vitro” [source: Science Signaling Vol. 100, No. 16, 2003] describes performing classification over the drug-induced genomic expression profiles to predict the clinical drug efficacy. However, such prior art references fail to disclose a method for discovering strong relevance in an unsupervised manner using entity co-occurrence graphs. Natural language processing techniques have also been adopted to mine relationships between biological entities from the text data (see for example, the paper to Coulet et al. titled “Integration and Publication of Heterogeneous Text-Mined Relationships on the Semantic Web” [source: Journal of Biomed Semantics, Vol. 2, Supplement 2, 2011], and the paper to Ramakrishnan et al. titled “Unsupervised Discovery of Compound Entities for Relationship Extraction” [source: Knowledge Engineering: Practice and Patterns, pages 146-155, 2008]). However, similar to the Semantic Web technologies, the approaches based on natural language processing can only detect relationships that are already expressed by words or phrases in the text corpus and fail to disclose a method for discovering strong relevance between drugs and diseases that may not necessarily have been written in the text or may not be directly linked in the co-occurrence graph, which is much more useful for new drug discovery.

Another family of related work involves recommendation systems, which suggest the items that the users are likely to be interested in (see, for example, the paper to Sen et al. titled “Tagommenders: Connecting Users to Items through Tags” [source: Proceedings of the 18^{th} International Conference on World Wide Web, 2009], the paper to Yin et al. titled “A Probabilistic Model for Personalized Tag Prediction” [source: In Proceedings of the 16^{th} ACM SIGKDD International Conference on Knowledge Discovery and Data Mining, 2010], and the paper to Guan et al. titled “Document Recommendation in Social Tagging Services” [source: Proceedings of the 19^{th} International Conference on World Wide Web, 2010]). Although a recommendation system also discovers unknown relationships, the problem addressed in this disclosure is fundamentally different from the classical recommendation problem as the current disclosure aims to develop a fully automatic approach that does not use any label information (while recommendation systems usually know some users are interested in certain items).

Given a graph, many methods have been developed for estimating relevance between two nodes. Personalized PageRank (as described in the paper to Jeh et al. titled “Scaling Personalized Web Search” [source: Twelfth International WWW Conference, 2003]) and SimRank (as described in the paper to Jeh et al. titled “Simrank: A Measure of Structural-Context Similarity” [source: Proceedings of the Eighth ACM SIGKDD International Conference on Knowledge Discovery and Data Mining, 2002]) are two representative prior art references for computing the similarity between two nodes of the same type in a homogeneous graph. However, it should be noted that such prior art references fail to account for the fact that different types of nodes carry different semantic meanings and should not be mixed. For heterogeneous graphs, PathSim (as described in the paper to Sun et al. titled “Pathsim: Meta Path-Based Top-k Similarity Search in Heterogeneous Information Networks” [source: PVLDB, Vol. 4 No. 11, 2011]) gives an interesting meta path based similarity measure between two nodes of the same type. HeteSim (as disclosed in the paper to Shi et al. titled “Relevance Search in Heterogeneous Networks” [source: EDBT, pages 180-191, 2012]) and Path Constrained Random Walk (as disclosed in the paper to Lao et al. titled “Fast Query Execution for Retrieval Models Based on Path-Constrained Random Walks” [source: Proceedings of the 16th ACM SIGKDD International Conference on Knowledge Discovery and Data Mining, pages 881-888, 2010]) estimate the relevance between different types of nodes following the random walk framework. However, it should be noted that the original HeteSim algorithm only uses the binary graph. Further, Path Constrained Random Walk favors the popular entities in an undesirable manner and ignores the differences of various contexts inherited from various meta paths.

In the medical domain, drug discovery studies (as in the paper to Gunther et al. titled “Prediction of Clinical Drug Efficacy by Classification of Drug-Induced Genomic Expression Profiles In Vitro” [source: Science Signaling, Vol. 100, no. 16, 2003], the paper to D. Searls titled “Data Integration: Challenges for Drug Discovery” [source: Nature Reviews Drug Discovery, Vol. 4, No. 1, 2005], and the paper to Ramakrishnan et al. titled “Unsupervised Discovery of Compound Entities for Relationship Extraction” [source: Knowledge Engineering: Practice and Patterns, pp. 146-155, 2008]) can only detect drugs that are known to treat certain diseases, and cannot discover strong relevance between drugs and diseases that are not explicitly written in the text or directly linked in the simple co-occurrence graph. Recommendation systems may suggest items that the users are likely to be interested in (see, for example, the paper to Sen et al. titled “Tagommenders: Connecting Users to Items through Tags” [source: Proceedings of the 18^{th} International Conference on World Wide Web, 2009], the paper to Yin et al. titled “A Probabilistic Model for Personalized Tag Prediction” [source: In Proceedings of the 16^{th} ACM SIGKDD International Conference on Knowledge Discovery and Data Mining, 2010], and the paper to Guan et al. titled “Document Recommendation in Social Tagging Services” [source: Proceedings of the 19^{th} International Conference on World Wide Web, 2010]). However, the systems require the availability of training data (e.g., some users are interested in certain items). Recent studies on similarity search in heterogeneous graphs, such as PathSim (as described in the paper to Sun et al. titled “Pathsim: Meta Path-Based Top-k Similarity Search in Heterogeneous Information Networks” [source: PVLDB, Vol. 4 No. 11, 2011]), explore an interesting meta path based similarity measure. Nevertheless, their similarity measure is defined for comparing nodes of the same types (e.g., similarity between authors in a bibliographic network). Shi et al., in the paper titled “Relevance Search in Heterogeneous Networks” [source: EDBT, pages 180-191, 2012], first proposed to study the relevance between heterogeneous entities. However, their similarity measure is based on pairwise random walk which may not be able to capture the subtlety of the path-constrained strong relevance relationships as indicated in experiments outlined later in this disclosure.

Embodiments of the present invention are an improvement over prior art systems and methods.

### SUMMARY OF THE INVENTION

The present invention provides a method comprising: receiving a co-occurrence graph among different entities, where each node in the co-occurrence graph represents an entity and two nodes in the co-occurrence graph are connected by an edge if they occur together in a document within a collection of documents, and where a weight on each edge equals a number of times two entities occur together in the collection of documents; receiving a query comprising a query entity name and a target entity type; receiving pre-specified meta paths to constrain a scope of co-occurrence between two different entities in the co-occurrence graph; and outputting entities that (i) belong to the target entity type, and (ii) are functionally relevant to an instance of the query entity name.

In an extended embodiment, the method comprises: building a probabilistic context-aware relevance model to measure the functional relevance between the query entity name and the target entity type, in view of the scope, by: (i) profiling the query entity name using a first set of adjacent entities within the scope; (ii) profiling the target entity type using a set of adjacent entities within the scope; (iii) wherein the functional relevance between the query entity name and the target entity type is a weighted product of the functional relevance between all pairs of adjacent entities, wherein one entity comes from the first set of adjacent entities and the other entity comes from the second set of adjacent entities; and (iv) iteratively computing the functional relevance between any pair of adjacent entities according to steps (i), (ii), and (iii); wherein the weight in step (iii) measures an inverse document frequency (IDF) based importance of adjacent entities to the query entity name and the target entity type.

The present invention provides a computer-implemented method comprising: receiving data associated with a co-occurrence graph among heterogeneous entities, the co-occurrence graph comprising a plurality of nodes, each node representing an entity in the heterogeneous entities, wherein any two nodes in the co-occurrence graph are connected by an edge when they co-occur in a knowledge base, with a weight of the edge being equal to the number of times entities associated with the two nodes co-occur in the knowledge base; receiving a query comprising a query entity name and a target entity type; receiving a plurality of meta paths to constrain co-occurrence scope of any two heterogeneous entities in the co-occurrence graph; generating a subgraph of the co-occurrence graph with path instances of the received meta paths; and outputting entities from the subgraph belonging to the target entity type and having strong relevance with the query entity name based on a probabilistic context-aware relevance model, where the strong relevance is constrained by the received meta paths.

The present invention also provides a non-transitory, computer accessible memory medium storing program instructions for mining strong relevance between heterogeneous entities from their co-occurrences comprising: computer readable program code receiving data associated with a co-occurrence graph among heterogeneous entities, the co-occurrence graph comprising a plurality of nodes, each node representing an entity in the heterogeneous entities, wherein any two nodes in the co-occurrence graph are connected by an edge when they co-occur in a knowledge base, with a weight of the edge being equal to the number of times entities associated with the two nodes co-occur in the knowledge base; computer readable program code receiving a query comprising a query entity name and a target entity type; computer readable program code receiving a plurality of meta paths to constrain co-occurrence scope of any two heterogeneous entities in the co-occurrence graph; computer readable program code generating a subgraph of the co-occurrence graph with path instances of the received meta paths; and computer readable program code outputting entities from the subgraph belonging to the target entity type and having strong relevance with the query entity name based on a probabilistic context-aware relevance model, where the strong relevance is constrained by the received meta paths.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 depicts a screenshot from the demo drug search engine.

FIG. 2 illustrates an example of the present invention's system framework.

FIG. 3 illustrates the degree distribution of the nodes in graph 6:

FIG. 4 illustrates a histogram of the number of times that the ground truth drug-disease pairs co-occur in text corpus D.

FIG. 5 and FIG. 6 illustrate a comparison of the present invention's model EntityRel with related work in Precision and Recall, respectively.

FIG. 7 depicts a non-limiting example of a system implementing the method of the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

Discovering strong relevance between heterogeneous entities from entity co-occurrence graphs is a fundamental problem in information retrieval. Entity co-occurrence graphs are common graphs in the real world, where each node represents one entity, and each edge encodes the number of times two entities co-occur in the text data or other data. It should be noted that the entities in an entity co-occurrence graph can be of heterogeneous types. The phrase “strong relevance” as used herein refers to the relevance supported by rich relevance contexts in the data. Given an entity as a query, a user may be interested in browsing other entities of heterogeneous types that have strong relevance relationships with the queried entity. With the discovery of strong semantic relationships between entities, huge knowledge networks can be built, and the user can navigate from one entity to other related entities and quickly find the information he/she is searching for.

Based on these considerations, the present invention contributes to the state-of-the-art in the following aspects: (1) the present invention extends the meta path based relationship analysis to heterogeneous types of entities; (2) a new measure on the strength of relevance relationships, EntityRel, is introduced by building a generative probabilistic model to compute the context-aware relevance between two heterogeneous entities; and (3) the effectiveness and efficiency of the present invention was demonstrated through experiments where the performance was compared with several existing methods with good results in the biomedical domain for the strong relevance discovery between drugs and diseases.

The entity co-occurrence graph maintains basic entity relationships between any two entities. Based on it, the collection of paths linking two heterogeneous entities eᵢ and eⱼ offer rich semantic contexts for their relationships. However, not all paths carry the same semantics. For example, “tretinoin—skin—acne” indicates a therapeutic relationship between drug “tretinoin” and disease “acne”, while “Vitamin A—toxicity—acne” indicates a side-effect relationship. Therefore, the relevance type depends on the contexts in paths. The proposed measure, EntityRel, is such a context-aware relevance measure. Without loss of generality, the following five types of entities are predefined for constructing the entity co-occurrence graph: “Drug”, “Compound”, “Disease”, “Target” and “MeSH”. Based on these entity types, path types like “Drug—Target—Disease” or “Drug—MeSH—Disease”, referred to as meta paths, are defined. For example, “tretinoin—skin—acne” is one path instance of meta path “Drug—Target—Disease”. The proposed measure, EntityRel, assumes that the relevance is only meaningful under path contexts constrained by certain meta path. For example, if all paths following the pattern “Drug—Target—Disease” are used as contexts, the discovered relationships between drugs and diseases are very likely therapeutic relationships. More specifically, the set of entities (excluding eᵢ and eⱼ) in these paths are named “reasoning entities”, which are used to reason the relevance relationships discovered.

Consequently, one natural question is: what kinds of paths are to be used for mining the strong relevance between heterogeneous entities? The definition of “strong” relevance is a data dependent concept: depending on how rich the corresponding relevance contexts provided by the data can be, some types of relevance might be strong and some types might be weak. In this invention, given two types of entities and k meta paths, such that the relevance contexts defined by these meta paths in data are relatively richer than other types of contexts. Based on these rich contexts, “strong” relevance between the given two types of entities can be discovered.

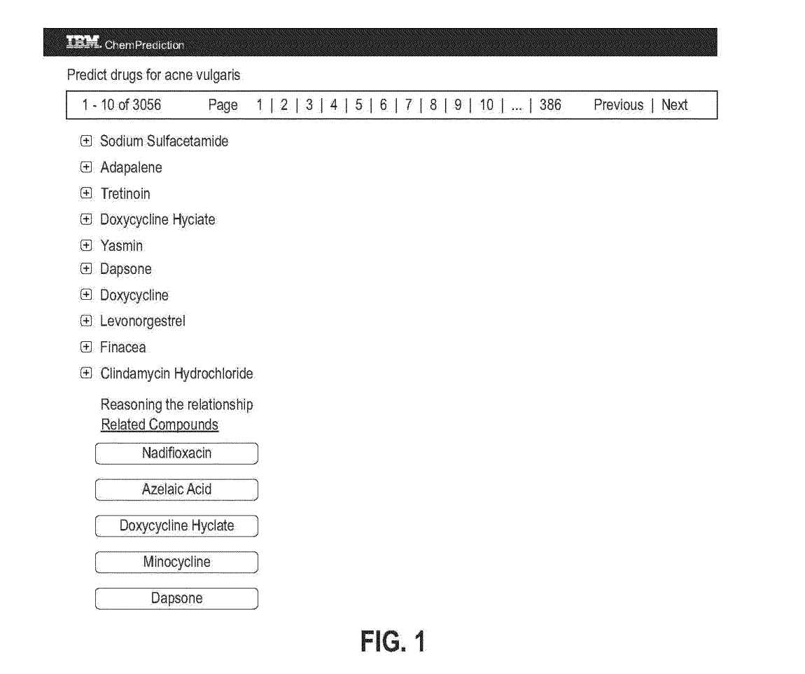

A prototype drug search engine was implemented as per the teachings of the present invention. FIG. 1 shows a real example in the present invention's demo system, where a user submits a disease “acne” (the disease “acne vulgaris” is its synonym) and searches for strongly relevant drugs. All the top ten returned results are FDA-approved drugs for treating acne. Specifically, the 10^{th} drug “Clindamycin Hydrochloride” only co-occurs with “acne” and its synonyms five times in more than 20 million MEDLINE® articles, which cannot be discovered by simple co-occurrence methods easily. Note that the correctness of strong relevance depends on the reasoning entities of the discovered relationship. All the five reasoning compounds (Nadifloxacin, Azelaic Acid, Doxycycline Hyclate, Minocycline, Dapsone) in the paths that contribute most to this discovery result clearly indicate that the strong relevance found between “Clindamycin Hydrochloride” and “acne” is a valid therapeutic relationship. On the contrary, if similar contexts were used to reason the relationship of “Vitamin A” (co-occur with acne 22 times) or “Insulin” (co-occur with acne 21 times) with “acne”, the relationship will be wrong despite that these two drugs are relevant to disease “acne” in other ways. For example, to treat acne, large doses of Vitamin A must be given, which then results in Vitamin A toxicity; acne has an effect of insulin resistance. These relationships have to be detected by other co-occurrence contexts, such as “Symptom”-typed entities. In this invention, when the correctness of the discovered strong relevance is judged, the set of reasoning entities involved in the relevance discovery is utilized.

Problem and Framework

In the undirected entity co-occurrence graph [symbol] , the nodes are heterogeneous entities and the edge between two entity nodes represents the fact that these two entities co-occur at least once in some knowledge base. Given one node eᵢ, its neighborhood set N(eᵢ) thus includes all other entities that co-occur with it in data. Given graph [symbol] , containing K types of predefined entities E₁, . . . , E_{K}, one problem is to automatically discover the strong relevance relationships between any pair of entities eᵢ and eⱼ strongly supported by [symbol] , where eᵢ and eⱼ can belong to either the same entity type or different entity types. As a more general case, in this invention the focus is placed on the relevance relationships across heterogeneous entity types. E(eᵢ) is annotated as the entity type name of eᵢ and |E(eᵢ)| as the number of entities of type E(eᵢ). Formally, the relevance relationship between two heterogeneous entities eᵢ and eⱼ is quantified in a probabilistic model as P(rel|eᵢ, eⱼ), where the relevance property is assumed to be binary with two values rel and r̅e̅l̅.

The computation of P(rel|eᵢ, eⱼ) depends on the edge between eᵢ and eⱼ in the graph [symbol] , representing the number of times they co-occur. However, merely using the direct edge connection in [symbol] cannot effectively capture the correlation contexts of eᵢ and eⱼ. Given two example entities “tetracycline” and “acne”, a number of paths can be extracted linking them, e.g., “tetracycline—skin—acne”, “tetracycline—protein synthesis inhibitor—bacterial infection—acne” etc., from the graph [symbol] . All these paths collectively serve as the correlation contexts for “tetracycline” and “acne”.

It is observed that, the correlation contexts between two entities can be manifested by other entities that connect with both in [symbol] : For example, from [symbol] , it is known that the disease “acne” co-occurs with the organism entity “skin”, which is one kind of target entity. It is also known that the drug “tetracycline” co-occurs with the target entity “skin” Thus, the target entity “skin” effectively links the drug entity “tetracycline” and the disease entity “acne” together and implies their relevance.

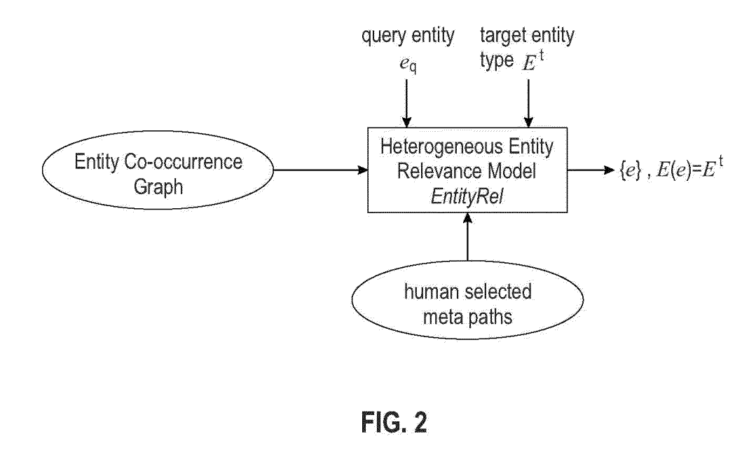

One task can be formulated as searching relevant heterogeneous entities by traveling the co-occurrence graph. For example, for discovering the relationships between drugs and diseases, the user inputs a disease entity “acne” and then searches all drug entities reachable in the graph 6: Under the path-based relevance discovery framework (see paper to Sun et al. titled “Pathsim: Meta Path-Based Top-k Similarity Search in Heterogeneous Information Networks” [source: PVLDB, Vol. 4 No. 11, 2011]), the present invention aims to automatically select the most effective meta paths encoding the most useful correlation contexts for the relevance discovery task. Without loss of generality, P(rel|eᵢ, eⱼ) is formulated as a search problem: P(rel|eᵢ, eⱼ) by treating e_{q}=eᵢ as the query entity, e=eⱼ as the searching target entity, and E(e)=E(eⱼ) which is the target entity type. The whole framework is given by FIG. 2.

Properties of the Co-Occurrence Graph

MEDLINE®, a bibliographic database of life sciences and biomedical information, is used as the knowledge base to discover entity relationships in this invention. The abstracts of all 20,642,063 biomedical documents to date consist of an unstructured data corpus [symbol] .

The following five types of biological entities were selected to study: “Drug”, “Disease”, “Compounds”, “Target” and “MeSH” terms (i.e., Medical Subject Heading terms). In total, 5,867 FDA-approved drugs were predefined; a dictionary of 4,244 diseases was extracted from human disease ontology; a set of 2,254 small-molecule chemical compounds with explicit drug indications was obtained from the Chemical Entities of Biological Interest (ChEBI) database; a dictionary of 11,280 targets made up of four sub-types: tissue, cell-line, protein, organism was extracted; and a set of all 17,347 leaf MeSH terms in the MeSH tree was used as the meta-data to index medical articles in MEDLINE® by National Institute of Health. All the above entities consist of the node set in the Entity Co-occurrence Graph [symbol] . An edge is put between two entities if they ever co-occur in the same MEDLINE® article, with the edge weight being the number of articles they co-occur. In other words, wᵢⱼ=co(eᵢ, eⱼ), where co(eᵢ, eⱼ) is the number of articles where both eᵢ and eⱼ occur in the text.

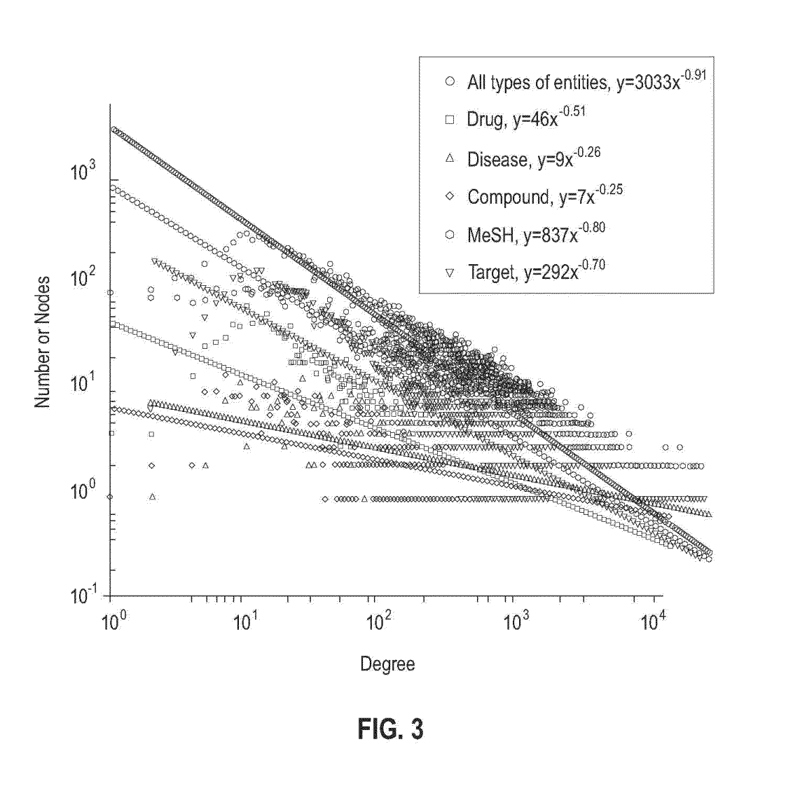

Here, some interesting properties of the co-occurrence graph [symbol] are studied. First, the degree distributions of [symbol] and individual entity type are depicted in FIG. 3. One interesting finding is that various entity types have various degree distributions, resulting in various graph structures. For example, both “Disease” and “Compound” have very flat power law slope, indicating that their node degrees are more uniformly distributed. In comparison, the other entity types contain fewer highly connected nodes. It is found that, if the entire graph was treated as a homogeneous graph without differentiating entity types and then randomly walk the graph, some entity types will be favored while some entity types are not reachable. Therefore, traditional methods to compute entity relevance in a homogeneous graph like the previously described SimRank and Personalized PageRank are not suitable for relevance between heterogeneous entities.

Graph [symbol] is a typical “small world”. 91.75% of its nodes belong to a giant connected component. The average distance between two nodes in this giant component is 2.0663, indicating that starting from one node, one can quickly arrive at other nodes. The “small world” phenomenon in [symbol] offers rich contexts (numerous different paths) between two nodes.

Meta Path Based Heterogeneous Entity Relevance Model

For the problem of searching relevant heterogeneous entity e of the target entity type E^{t} in graph [symbol] or a query entity e_{q}, one key task is to compute P(rel|e_{q}, e) based on meta paths, which are discussed in detail below.

Meta Paths as Contexts

As noted before, given the co-occurrence graph [symbol] , the task of entity relevance relationship discovery may be formulated as searching relevant heterogeneous entities in the graph. For example, given the disease “acne”, what are the similar drugs in the graph? The objective of the problem is to infer the probability P(rel|e_{q}, e), given the query entity e_{q} and one entity e with the target entity type.

Previously, the graph [symbol] has been shown to be extremely complicated and overwhelming across different entity types. Given two heterogeneous entities e_{q} and e, there exists numerous paths linking them if the length of the path is not constrained. More specifically, due to the “small world phenomena” in [symbol] , most pairs of entities can be linked together within two steps. However, it is not optimal to recommend all entities as a response to the query. Instead, relevant entities should be found based on the semantic context encoded in the paths linking two entities.

The definition of meta path is given as follows:

Definition 1. Meta Path. A meta path m of length l is a sequence of nodes in the form of

$${E}_{{x}_{1}} {\to }^{{A}_{{x}_{1} , {x}_{2}}} {E}_{{x}_{2}} {\to }^{{A}_{{x}_{2} , {x}_{3}}} … {E}_{{x}_{l - 1}}$$

where x_{y}ε[1,K],yε[1,l]. Aₓ_{_{y}}_{,x}_{_{y+1}} defines a composite correlation between two entity types Eₓ_{_{y}} and Eₓ_{_{y+1}}.

One meta path linking two types of entities offers rich semantic context for relevance discovery between the two entity types. How to select the most useful meta paths for a task is beyond the scope of this invention. Here, it is assumed that k meta paths are given by domain experts as the relevance contexts. Based on the selected meta paths, a core task is to compute P(rel|e_{q}, e).

Review Related Work in Computing P(rel|e_{q}, e)

The related work in computing P(rel|e_{q}, e) can be categorized along two dimensions: context-aware and context-agnostic; homogeneous and heterogeneous. The previously described Personalized PageRank computes the probability of a random walker starting from e_{q} and arriving at e in the graph as P(rel|e_{q}, e), where the teleport only switches to the query entity e_{q}. As a general-purpose graph similarity measure, Personalized PageRank is a context-agnostic model designed for a homogeneous graph. Its variation, called Path Constrained Random Walk (as described in the paper to Lao et al. titled “Fast Query Execution for Retrieval Models Based on Path-Constrained Random Walks” [source: KDD, pp. 881-888, 2010]), is extended for heterogeneous graphs. It computes the probability of a random walker starting from e_{q} and arriving at e through constrained paths in the graph as P(rel|e_{q}, e). It is designed for a single meta path. Such random walk models, however, favor the popular entities in an undesirable manner and ignore the differences of various contexts inherited from various meta paths.

The previously described SimRank is another context-agnostic model designed for the homogeneous graph. It iteratively computes P(rel|e_{q}, e) as the sum of similarities between their neighbors in the graph. The entity types of their neighbors are ignored. The previously described HeteSim extended SimRank to the heterogeneous graph. Given a meta path, it computes the average fraction of information that can diffuse from the middle node of the path to two ends as P(rel|e_{q}, e). However, HeteSim only depends on the raw counts of paths without fully utilizing the rich contexts of these paths.

Context-Aware Relevance Model

The present invention's relevance measure for two heterogeneous entities fully considers the subtlety of different types among entities and factors in the meta paths as the correlation contexts. One straightforward way of satisfying all the above conditions is a probabilistic model conditioned on k pre-given meta paths. Formally, such a model is defined as:

P(rel|e_{q},e)=ΣₘP(m)P(rel|e_{q},e,m) (1)

P(rel|e_{q}, e) can be seen as a linear combination of the relevance conditioned on each meta path m. The meta path P(m) can be learned in a supervised manner (see paper to Lao et al. titled “Relational Retrieval Using a Combination of Path-Constrained Random Walks” [source: Machine Learning, Vol. 81, pp. 53-67, 2004]). In the present invention, the weights of meta paths are preferably manually tuned, with the focus placed on the computation of P(rel|e_{q}, e, m).

Following the Robertson-Sparck Jones probabilistic relevance framework (as described in the paper to Jones et al. titled “A Probabilistic Model of Information Retrieval: Development and Comparative Experiments” [source: Information Processing and Management, Vol. 36, pp. 779-808, 2000]), P(rel|e_{q}, e, m) is as follows:

$$P ( rel \vert {e}_{q} , e , m ) {∝}_{{e}_{q}} \frac{P ( rel \vert {e}_{q} , e , m )}{P ( \overline{rel} \vert {e}_{q} , e , m )} = \frac{P ( e \vert rel , {e}_{q} , m ) P ( rel \vert {e}_{q} , m )}{P ( e \vert \overline{rel} , {e}_{q} , m ) P ( \overline{rel} \vert {e}_{q} , m )} {∝}_{{e}_{q}} \frac{P ( e \vert rel , {e}_{q} , m )}{P ( e \vert \overline{rel} , {e}_{q} , m )} \approx {\prod }_{f ∈ F} \frac{P ( f \vert rel )}{P ( f \vert \overline{rel} )} \qquad ( 2 )$$

where F defines a feature space of target entity e constrained by the meta path m and f is one feature in F. In graph [symbol] , all neighboring entities along the meta path m are used as the features to model each entity. That is to say,

$$P ( rel \vert {e}_{q} , e , m ) \approx {\prod }_{f ∈ N ( e )} \frac{P ( f \vert rel )}{P ( f \vert \overline{rel} )} \qquad ( 3 )$$

where N(e_{q}) denotes the set of entities linked with e in [symbol] .

When no labeled training is available, it is difficult to estimate P(f|rel). However, estimating P(f| r̅e̅l̅) is trivial, since it can be assumed that all the other entities are non-relevant following the same assumption made by Jones et al. in their paper titled “A Probabilistic Model of Information Retrieval: Development and Comparative Experiments” [source: Information Processing and Management, Vol. 36, pp. 779-808, 2000]). For example, given one disease, almost all drugs in the data are non-relevant. This assumption leads to an IDF-like approximation for P (f| r̅e̅l̅).

Now, the question is to construct the probability distribution P(f|rel) without training data.

Note that N(e_{q}) defines the features of e_{q} and N(e) defines the features of e. Suppose one repeatedly samples |N(e_{q})| times from an unknown relevance model rel and generates the query entity e_{q}. The question is: what is the probability that the next feature that is sampled from rel will be fεN(e)? This generative probability is used to estimate P(f|rel):

$$P ( f \vert rel ) \approx P ( f \vert N ( {e}_{q} ) ) = \frac{P ( f , N ( {e}_{q} ) )}{P ( N ( {e}_{q} ) )} {∝}_{{e}_{q}} P ( f , N ( {e}_{q} ) ) \qquad ( 4 )$$

By making the assumption that the neighboring entities of e_{q} are conditionally independent of each other given f, one gets:

P(f,N(e_{q}))=P(f)Π_{f}_{_{q}}_{εN(e}_{_{q}}₎P(f_{q}|f) (5)

In Eq. 5, P(f_{q}|f) defines the probability of generating one query feature f_{q} from one target entity feature f. Interestingly, since both f_{q} and f are also entities in the graph and can be modeled by their own neighboring entities, P(f_{q}|f) defines the language model approach if f_{q} is treated as a new query entity and f as a new target entity. As this language model is actually equivalent to the traditional probabilistic model described in Eq. 2 based on the paper to Lafferty et al. titled “Probabilistic Relevance Models Based on Document and Query Generation” [source: Language Modeling and Information Retrieval, pp. 1-10, 2002], one gets P(f_{q}|f)≈P(rel|f_{q}, f, m). Substituting all the above into Eq. 3, the final solution is obtained:

$$\begin{matrix}P ( rel \vert {e}_{q} , e , m ) \approx {\prod }_{f ∈ N ( e )} \frac{P ( f ) {\prod }_{{f}_{q} ∈ N ( {e}_{q} )} P ( rel \vert {f}_{q} , f , m )}{1 / i ef ( f , e )} \\ \approx {\sum }_{f ∈ N ( e )} {\sum }_{f ∈ N ( {e}_{q} )} log \frac{c o ( f , e ) ief ( f , e )}{{\sum }_{g ∈ E ( f )} c o ( g , e )} \\ P ( rel \vert {f}_{q} , f , m )\end{matrix} \qquad ( 6 )$$

where P(f) captures the co-occurrence count co(f, e) and can be defined as P(f)=co (f,e)/Σ_{gεE(f)}co(g,e) in the context of meta path m. ief(f, e) represents the “inverse entity frequency” which measures whether entities f and e are common or rare within all the co-occurrence between entities of type E(f) and E(e):

$$ief ( f , e ) = log \frac{( \vert E ( f ) \vert + \vert E ( e ) \vert ) / 2}{1 + ( \vert N ( f ) Λ E ( e ) \vert + \vert N ( e ) Λ E ( f ) \vert ) / 2} \qquad ( 7 )$$

where N(f)ΛE(e) represents the joint set of entities who are neighborhoods of f and have the same entity type as e.

The present invention's probabilistic model defines an iterative process to compute the relevance between two heterogeneous entities conditioned on the context of meta path m. Intuitively, it sums the weights of all path instances of meta path m from e_{q} to e. For initialization, P(rel|eᵢ,eⱼ,m)=1, if eᵢ=eⱼ; otherwise 0 if eᵢ!=eⱼ.

Experiments

In this section, the effectiveness of the proposed method is empirically evaluated for estimating the relevance between heterogeneous entities. The experimental setup is first addressed.

Experimental Setup

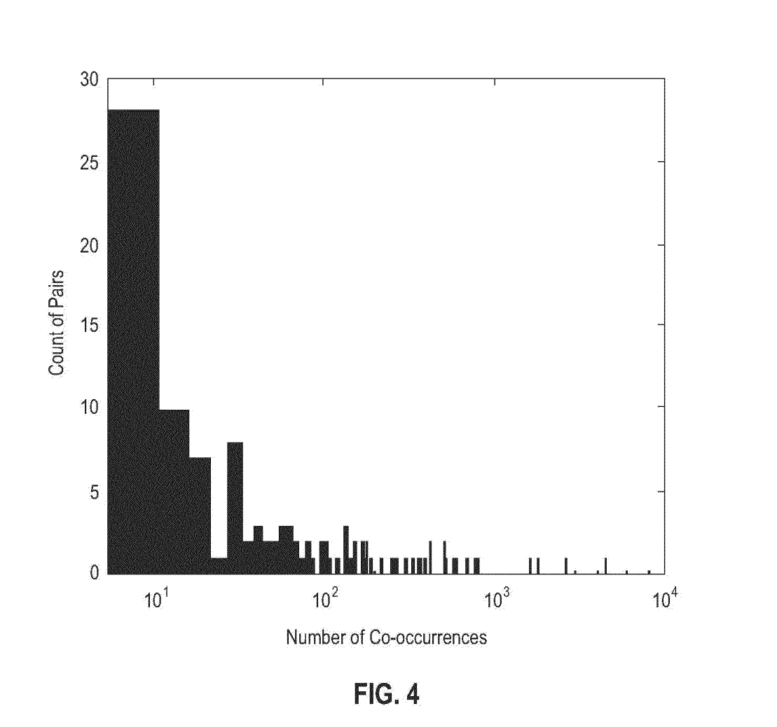

In order to evaluate the relevance estimation results generated by different algorithms, 199 unique drug-disease pairs were sampled from FDA's orange book as the ground truth for the therapeutic relationships between drugs and diseases. The therapeutic relationship was chosen in testing cases because it is one kind of strong relevance largely supported by the MEDLINE® data. While sampling, well-known drugs are avoided, as their relevance can be easily captured by their large amount of co-occurrences with diseases. The co-occurrence distribution of the ground truth drug-disease pairs is illustrated by FIG. 4. It can be observed that most of the drugs that are known to treat certain diseases co-occur rarely with the disease (typically, no more than 10 times out of the 20 million abstracts). Therefore, the relevance relationship that needs to be discovered is really hidden in the text and can hardly be discovered by simply counting the raw co-occurrence numbers or natural language processing techniques.

Given a disease, all drugs in the database can be ranked according to the relevance scores, denoting how likely each drug is relevant to the disease. Since only ground truths for the therapeutic relationship is available (not for strong relevance in general), it is difficult to judge the “correct” returned drug. To evaluate the correctness of a returned drug, not only will the drug be compared with ground truths (for Recall), but the reasoning entities will also be manually checked by human experts to see if the inferred relationship falls in the treatment category (for Precision). Standard precision, recall and Mean Average Precision (MAP) (as described in the book to Manning et al. titled “Introduction to Information Retrieval” [source: Cambridge University Press, 2008]) are used to evaluate the results. Precision is defined as the number of drugs that can treat the query disease based on human evaluation by the number of returned drugs. Recall is defined as the number of drugs in ground truths divided by the number of returned drugs. Given a disease, let r be the judgment score of the drug ranked at position i, where r=1 if the drug is known to treat the disease and r=0 otherwise. Then, the Average Precision (AP) is computed as follows:

$$A P = \frac{{\sum }_{i} {r}_{i} \times Precision @ i}{\# of drugs known to treat the disease}$$

MAP is the average of AP over all the diseases in the labeled set. Normalized Discount Cumulative Gain (NDCG) cannot be used to measure the performance, since whether a drug can or cannot treat the given disease is manually judged and levels regarding how much one drug can treat one disease is not available.

Comparing Different Relevance Estimation Methods

The following five meta paths that domain experts think are useful for discovering strong relevance between drugs and diseases were tried:
Drug-Disease
Drug-Drug-Disease
Drug-Compound-Disease
Drug-Disease-Disease
Drug-MeSH-Disease

Based on a single meta path, relevant drugs may be discovered using the present invention's proposed EntityRel model. As mentioned before, several state-of-the-art algorithms can also be used to estimate relevance between two homogeneous or heterogeneous entities. Such algorithms were applied on the original co-occurrence graph [symbol] and their performance were found to be poor. From Eq. 6, a better weight function for the edges in the entity graph could be defined as follows:

$${w}_{ij} = \frac{co ( {e}_{i} , {e}_{j} ) ief ( {e}_{i} , {e}_{j} )}{( {\sum }_{e ∈ E ( {e}_{j} )} c o ( e , {e}_{i} ) + {\sum }_{e ∈ E ( {e}_{i} )} c o ( e , {e}_{j} ) ) / 2} \qquad ( 8 )$$

It should be note that the weight function in Eq. 6 is modified in order to make the weight definition symmetric, i.e., wᵢⱼ=wⱼᵢ. Moreover, the log operation is removed such that the weight on each edge could be positive. [symbol] is used to denote the entity graph with the weight defined in Eq. 8. Several state-of-the-art relevance estimation algorithms were adopted on [symbol] and significant performance improvement was observed as compared to using the original co-occurrence graph [symbol] . Therefore, [symbol] was used instead of [symbol] in all the experiments. Existing relevance estimation methods were run on the heterogeneous entity graph [symbol] ′ generated by the given five meta paths only, with the same weight function in Eq. 8 for a fair comparison. The following are the state-of-the-art algorithms that were compared in the experiments:
Personalized PageRank. The damping factor is set as 0.9. By ignoring the type difference among entities and links, it can be run on two different graphs: (1) the entire entity graph [symbol] , named P-PageRank; and (2) the graph [symbol] ′ which only contains the given five meta paths, denoted by P-PageRank (MP).
SimRank. The damping factor is set to 0.8. As above, it has two versions: SimRank on [symbol] and SimRank (MP) on [symbol] ′.
HeteSim run on its best meta path.
Path Constrained Random Walk (PCRW) run on its best meta path.

HeteSim, PCRW and the present invention's method EntityRel are all based on the five meta paths given by domain experts. Combining the results generated by multiple meta paths could possibly perform better than a single meta path. In this example, HeteSim, PCRW and the present invention's method were run on each of the given five meta paths and the best results chosen for comparison.

It is worth noting that both original SimRank and original HeteSim work on binary graphs only, considering whether two nodes are connected or not, and ignoring the weight on the edges. The original versions were tried on the binary entity graphs without using the weighted edges, and it was found that they performed rather poorly. Therefore, the results of these two methods are shown on the weighted entity graph only (using the weight function in Eq. 8).

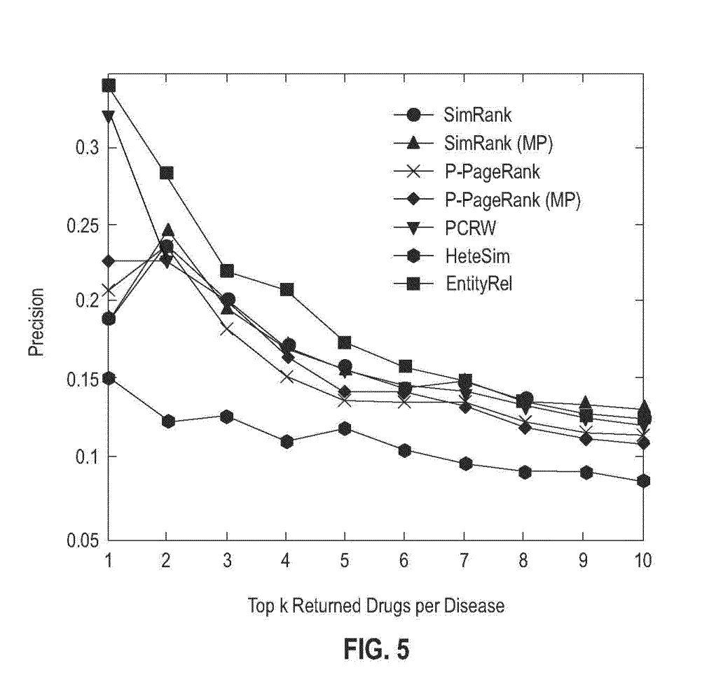

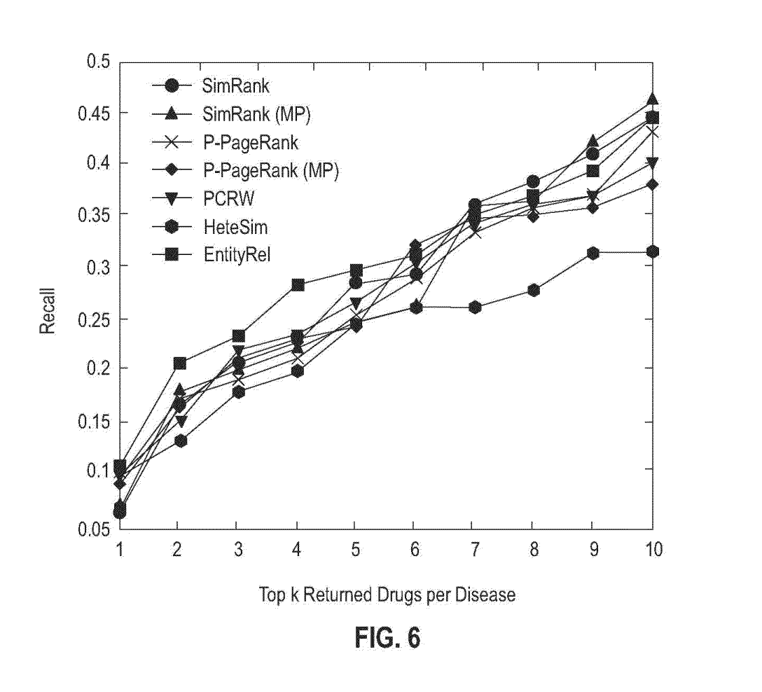

From the average precision curves and recall curves shown in FIG. 5 and FIG. 6, it is seen that the present invention's EntityRel model leads the pack, especially when the number of returned drugs is small. PCRW performs the second best. Another observation is that SimRank performs similarly on the complete entity graph [symbol] and the graph only containing the given five meta paths [symbol] ′, and so does P-PageRank. This indicates that while reducing the time and space complexity largely, the given five selected meta paths capture most of the useful information in the entire entity graph. The MAP scores of different algorithms are shown in Table 1 below. It is seen that the present invention's EntityRel is still the best, indicating its reliable performance over the entire ranking list of returned drugs.

TABLE 1
Comparison of EntityRel to Related Work in MAP

| Algorithm | MAP |
|---|---|
| SimRank | 0.251 |
| SimRank (MP) | 0.254 |
| P-PageRank | 0.245 |
| P-PageRank (MP) | 0.244 |
| PCRW | 0.253 |
| HeteSim | 0.204 |
| EntityRel | 0.276 |

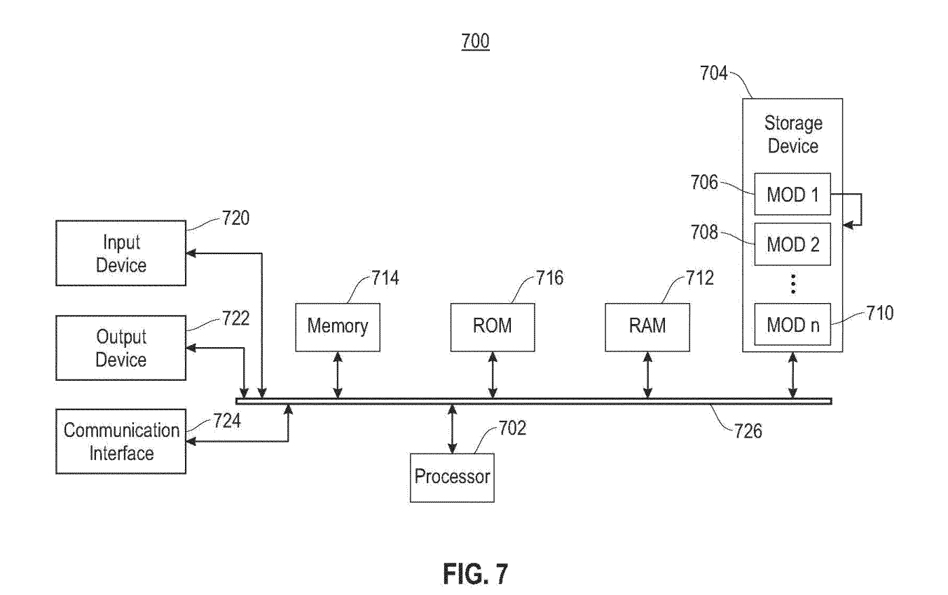

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 7 can practice all or part of the recited methods, can be a part of the recited systems, and/or can operate according to instructions in the recited non-transitory computer-readable storage media. With reference to FIG. 7, an exemplary system includes a general-purpose computing device 700, including a processing unit (e.g., CPU) 702 and a system bus 726 that couples various system components including the system memory such as read only memory (ROM) 716 and random access memory (RAM) 712 to the processing unit 702. Other system memory 714 may be available for use as well. It can be appreciated that the invention may operate on a computing device with more than one processing unit 702 or on a group or cluster of computing devices networked together to provide greater processing capability. A processing unit 702 can include a general purpose CPU controlled by software as well as a special-purpose processor.

The computing device 700 further includes storage devices such as a storage device 704 such as, but not limited to, a magnetic disk drive, an optical disk drive, tape drive or the like. The storage device 704 may be connected to the system bus 726 by a drive interface. The drives and the associated computer readable media provide nonvolatile storage of computer readable instructions, data structures, program modules and other data for the computing device 700. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 700, an input device 720 represents any number of input mechanisms, such as a microphone for speech, a touch-sensitive screen for gesture or graphical input, keyboard, mouse, motion input, speech and so forth. The output device 722 can also be one or more of a number of output mechanisms known to those of skill in the art. In some instances, multimodal systems enable a user to provide multiple types of input to communicate with the computing device 700. The communications interface 724 generally governs and manages the user input and system output. There is no restriction on the invention operating on any particular hardware arrangement and therefore the basic features may easily be substituted for improved hardware or firmware arrangements as they are developed.

Logical operations can be implemented as modules configured to control the processor 702 to perform particular functions according to the programming of the module. FIG. 7 also illustrates modules MOD 1 706, as well as MOD 2 708 through MOD n 710, which are modules controlling the processor 702 to perform particular steps or a series of steps. These modules may be stored on the storage device 704 and loaded into RAM 712 or memory 714 at runtime or may be stored as would be known in the art in other computer-readable memory locations.

Modules MOD 1 706, MOD 2 708 and MOD 3 710 may, for example, be modules controlling the processor 702 to perform the following steps: (a) receive pre-specified meta paths (a sequence of entity types that begins with the starting entity type and ends with the target entity type) to constrain the scope of the co-occurrence between two different entities in the co-occurrence graph; and (b) output entities that (i) belong to the target entity type and (ii) are functionally relevant (e.g., of medical interest) to an instance of the starting entity type.

Modules MOD 1 706, MOD 2 708 and MOD 3 710 may, for example, be modules controlling the processor 702 to perform the following steps: (a) receive data associated with a co-occurrence graph among heterogeneous entities, the co-occurrence graph comprising a plurality of nodes, each node representing an entity in the heterogeneous entities, wherein any two nodes in the co-occurrence graph are connected by an edge when they co-occur in a knowledge base, with a weight of the edge being equal to the number of times entities associated with the two nodes co-occur in the knowledge base; (b) receive a query comprising a query entity name and a target entity type; receiving a plurality of meta paths to constrain co-occurrence scope of any two heterogeneous entities in the co-occurrence graph; (c) generate a subgraph of the co-occurrence graph with path instances of the received meta paths; and (d) output entities from the subgraph belonging to the target entity type and having strong relevance with the query entity name based on a probabilistic context-aware relevance model, where the strong relevance is constrained by the received meta paths.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### CONCLUSION

A system and method has been shown in the above embodiments for the effective implementation of a system, method and article of manufacture for mining strong relevance between heterogeneous entities from their co-occurrences. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A computer-implemented method comprising:
receiving data associated with a co-occurrence graph among heterogeneous entities, said co-occurrence graph comprising a plurality of nodes, each node representing an entity in said heterogeneous entities, wherein any two nodes in said co-occurrence graph are connected by an edge when they co-occur in a knowledge base, with a weight of said edge being equal to the number of times entities associated with said two nodes co-occur in said knowledge base;
receiving a query comprising a query entity name and a target entity type;
receiving a plurality of meta paths to constrain co-occurrence scope of any two heterogeneous entities in said co-occurrence graph;
generating a subgraph of said co-occurrence graph with path instances of said received meta paths; and
outputting entities from said subgraph belonging to said target entity type and having strong relevance with said query entity name based on a probabilistic context-aware relevance model, where said strong relevance is constrained by said received meta paths.

2. The computer-implemented method of claim 1, wherein said query entity name is a disease name and said target entity type is “Drug”.

3. The computer-implemented method of claim 1, wherein said data associated with said co-occurrence graph is built from a plurality of the following: FDA-approved drugs, diseases extracted from human disease ontology, small-molecule chemical compounds with drug indications from a first database, terms in a tree used as a metadata to index documents in a second database, and targets made up of four sub-types: tissue, cell-line, protein, and organism.

4. The computer-implemented method of claim 1, wherein said received meta paths are any of, or a combination of, the following: “Drug-Disease”, “Drug-Drug-Disease”, “Drug-Compound-Disease”, “Drug-Disease-Disease” and “Drug-MeSH Term-Disease”.

5. The computer-implemented method of claim 1, wherein said heterogeneous entities are selected from any of the following: drug, compound, disease, target, and Medical Subject Headings (MeSH).

6. The computer-implemented method of claim 1, wherein said heterogeneous entities are heterogeneous biological and/or chemical entities.

7. The computer-implemented method of claim 1, wherein said knowledge base is accessible over a network.

8. The computer-implemented method of claim 7, wherein said network is any of the following: local area network (LAN), wide area network (WAN), the Internet, or cellular network.

9. A non-transitory, computer accessible memory medium storing program instructions for mining strong relevance between heterogeneous entities from their co-occurrences comprising:
computer readable program code receiving data associated with a co-occurrence graph among heterogeneous entities, said co-occurrence graph comprising a plurality of nodes, each node representing an entity in said heterogeneous entities, wherein any two nodes in said co-occurrence graph are connected by an edge when they co-occur in a knowledge base, with a weight of said edge being equal to the number of times entities associated with said two nodes co-occur in said knowledge base;
computer readable program code receiving a query comprising a query entity name and a target entity type;
computer readable program code receiving a plurality of meta paths to constrain co-occurrence scope of any two heterogeneous entities in said co-occurrence graph;
computer readable program code generating a subgraph of said co-occurrence graph with path instances of said received meta paths; and
computer readable program code outputting entities from said subgraph belonging to said target entity type and having strong relevance with said query entity name based on a probabilistic context-aware relevance model, where said strong relevance is constrained by said received meta paths.

10. A method comprising:
receiving a co-occurrence graph among different entities, wherein (i) each node in said co-occurrence graph represents an entity and (ii) two nodes in said co-occurrence graph are connected by an edge if they occur together in a document within a collection of documents, and wherein a weight on each edge equals the number of times two entities occur together in said collection of documents;
receiving a query comprising a query entity name and a target entity type;
receiving pre-specified meta paths to constrain a scope of co-occurrence between two different entities in said co-occurrence graph; and
outputting entities that (i) belong to said target entity type, and (ii) are functionally relevant to an instance of said query entity name.

11. The method of claim 10, comprising:
building a probabilistic context-aware relevance model to measure said functional relevance between said query entity name and said target entity type, in view of said scope, by:
(i) profiling said query entity name using a first set of adjacent entities within said scope;
(ii) profiling said target entity type using a set of adjacent entities within said scope;
(iii) wherein said functional relevance between said query entity name and said target entity type is a weighted product of the functional relevance between all pairs of adjacent entities, wherein one entity comes from said first set of adjacent entities and the other entity comes from said second set of adjacent entities; and
(iv) iteratively computing the functional relevance between any pair of adjacent entities according to steps (i), (ii), and (iii);
wherein said weight in step (iii) measures an inverse document frequency (IDF) based importance of adjacent entities to said query entity name and said target entity type.

12. The computer-implemented method of claim 10, wherein said query entity name is a disease name and said target entity type is “Drug”.

13. The method of claim 10, wherein data associated with said co-occurrence graph are built from a plurality of the following: FDA-approved drugs, diseases extracted from human disease ontology, small-molecule chemical compounds with drug indications from a first database, terms in a tree used as a metadata to index documents in a second database, and targets made up of four sub-types: tissue, cell-line, protein, and organism.

14. The method of claim 10, wherein said received meta paths are any of, or a combination of, the following: “Drug-Disease”, “Drug-Drug-Disease”, “Drug-Compound-Disease”, “Drug-Disease-Disease” and “Drug-MeSH Term-Disease”.

15. The method of claim 10, wherein said heterogeneous entities are selected from any of the following: drug, compound, disease, target, and Medical Subject Headings (MeSH).

16. The method of claim 10, wherein said heterogeneous entities are heterogeneous biological and/or chemical entities.

17. The method of claim 10, wherein said collection of documents are accessible over a network.

18. The method of claim 18, wherein said network is any of the following: local area network (LAN), wide area network (WAN), the Internet, or cellular network.
